(19) United States
(12) Patent Application Publication
(10) Pub. No.: US 2014/0090204 A1
(43) Pub. Date: Apr. 3, 2014

(54) Adjustable Friction Hinge

(71) Applicant: GEM PRODUCTS, INC., Orange Park, FL (US)

(72) Inventors: Jason Sarnowski, Jacksonville, FL (US); Erle Matthew Bridgewater, St. Johns, FL (US); Erik D. Spilling, St. Augustine, FL (US)

(73) Assignee: GEM Products, Inc., Orange Park, FL (US)

(21) Appl. No.: 13/631,023

(22) Filed: Sep. 28, 2012

(51) Int. Cl. E05D 11/08; E05D 3/02

(52) U.S. Cl. 16/340

(57) ABSTRACT

An adjustable friction hinge that implements a sex bolt in the barrel of the hinge is disclosed. One or more washers can be concentrically arranged about the sex bolt and can interact with the portions of the leaves of the hinge to create the necessary friction to maintain a desired hinge position. An indent can also be provided on the friction hinge to abut an interior of the sex bolt and prevent loosening of the sex bolt during use. The sex bolt acts as a more stable structural backbone as compared to the prior art adjustable hinge and includes a receiving portion where a common tool can be used to reduce or increase the amount of friction in the hinge. The washer configuration of the present application exhibits little to no wear characteristics over time.

### TECHNICAL FIELD OF THE INVENTION

The present application relates to hinges. Particularly, the present application relates to an adjustable friction hinge.

### BACKGROUND OF THE INVENTION

Friction hinges are commonly used to rotatably couple two objects together, such as a door or hatch to a base. The hinge is movable between an open and closed position and can maintain its position due to friction in the barrel of the hinge. For example, a laptop computer typically includes a friction hinge that couples the computer screen to the base of the computer. A user can therefore adjust their computer screen to the angle of their liking, and the friction hinge will hold the computer screen in place.

Conventional friction hinges wear over time and become loose. After a certain number of rotations, the friction hinge will fail to hold its position due to the frictional components of the hinge having worn against one another. Without the required friction between these components, the hinge freely moves between the open and closed positions without maintaining any stability at the desired angle. For example, after years of use, a laptop friction hinge can wear such that the computer screen is unable to maintain its desired angle and, instead, the user is required to hold the screen during use.

Adjustable friction hinges are known in the art for various applications. Such friction hinges include a fastener at one end and a nut at the other end. The fastener can be rotated and secured into the nut until a sufficient amount of friction is established.

### SUMMARY OF THE INVENTION

Adjustable friction hinges typically include a complex structure requiring a fastener and nut to engage one another, and several intermediary components to facilitate the required friction. The fastener is weakly situated and unable to withstand a large load. Further, the fastener loosens over time and bends due to its small radial midsection compared to the overall thickness of the hinge.

The present application discloses an adjustable friction hinge that implements a sex bolt in the barrel of the hinge and an indent that prevents loosening of the hinge over time. One or more washers can be concentrically arranged about the sex bolt and can interact with portions of the leaves of the hinge to create the necessary friction and maintain a desired hinge position. The sex bolt acts as a more stable structural backbone as compared to the prior art adjustable hinge, and the washer(s) engage one another, or the portions of the leaves, such that little or no friction is lost over time due to wear. The sex bolt includes a receiving portion where a common tool can be used to reduce or increase the amount of friction in the hinge.

In particular, the present application discloses an adjustable friction hinge including a first leaf, a second leaf hingedly coupled to the first leaf, a sex bolt coupling the first leaf to the second leaf, and at least one washer concentrically arranged about the sex bolt and adapted to frictionally engage at least one of the first and second leaves to create friction and maintain a hinge position.

Also disclosed is a method of adjusting a friction hinge including providing an adjustable friction hinge including a first leaf, a second leaf hingedly coupled to the first leaf, a sex bolt coupling the first leaf to the second leaf, the sex bolt having a receiving portion, and at least one washer concentrically arranged about the sex bolt and adapted to frictionally engage at least one of the first and second leaves to create friction and maintain a hinge position, inserting a tool into the receiving portion; and rotating the tool to thereby adjust the resistance in the adjustable friction hinge.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is front isometric view of the adjustable friction hinge according to one embodiment of the present application.

FIG. 2 is a sectional view of the friction hinge illustrated in FIG. 1.

FIG. 3 is an exploded view of the adjustable friction hinge according to one embodiment of the present application.

FIG. 4 is a front sectional view of a grooved washer according to one embodiment of the present application.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses an adjustable friction hinge that implements a sex bolt in the barrel of the hinge and one or more washers concentrically arranged about the sex bolt. The sex bolt can be pressed with a tool to create a dent that prevents loosening of the sex bolt over time. The sex bolt acts as a more stable structural backbone and the one or more washers can interact with portions of the leaves of the hinge to create the necessary friction to maintain a desired position. Accordingly, the friction hinge of the present application exhibits little to no wear characteristics and can be adjusted by a common tool if the friction of the hinge is more or less than desired.

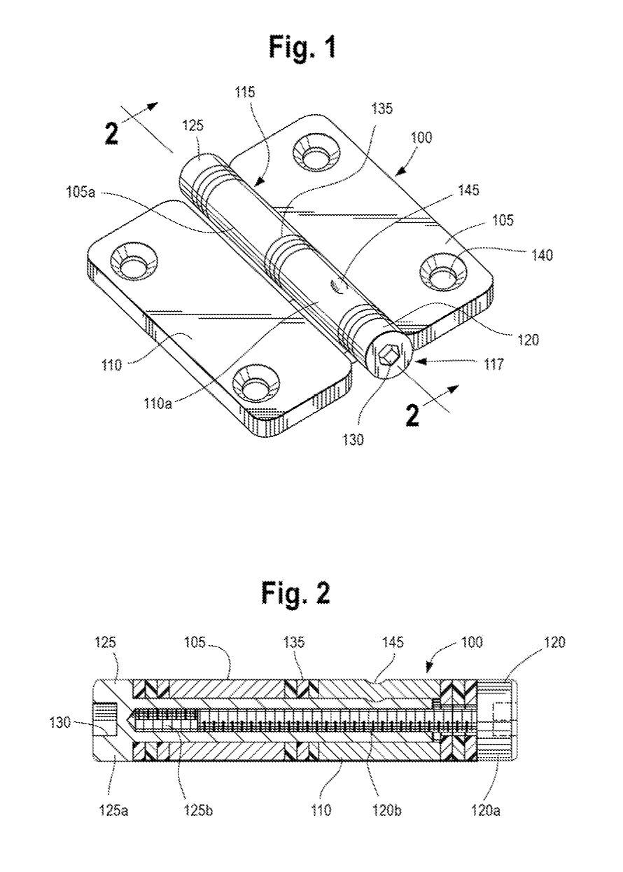

As shown, FIG. 1 discloses a hinge 100 in accordance with an embodiment of the present application. The hinge 100 includes a first leaf 105 and a second leaf 110, rotatably coupled together at a barrel 115. The barrel 115 includes a first curled portion 105a of the first leaf 105, and a second curled portion 110a of the second leaf 110. The curled portions 105a, 110a are coupled together by a sex bolt 117 including a male portion 120 and a female portion 125. The sex bolt 117 includes one or more receiving portions 130 to receive a simple tool such as an Allen wrench or a screwdriver to adjust the resistance of the hinge 100 when rotated. Further, one or more washers 135 can be provided between the curled portions 105a, 110a to frictionally abut other washers 135 or the curled portions 105a, 110a. Openings 140 can optionally be defined by the first and second leaves 105, 110 so that the hinge 100 can couple to a base or a door, for example.

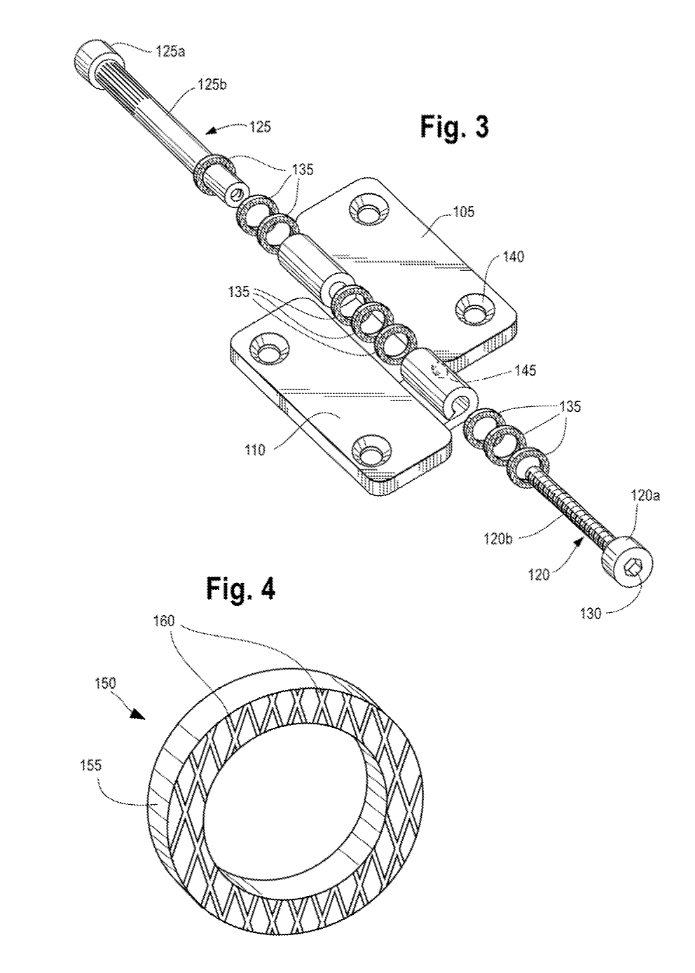

As shown in FIGS. 2 and 3, the male portion 120 includes a male portion head 120a and a threaded shaft 120b extending from the male portion head 120a. Further, the female portion 125 includes a female portion head 125a and a tubular threaded cavity 125b adapted to receive the threaded shaft 120b. The male 120 and female 125 portion therefore collectively make up a sex bolt that provides structural rigidity to the hinge 100 while allowing the washers 135 to be concentrically arranged about the sex bolt and frictionally engage the first 105 or second 110 leaves or other washers 135. By rotating the male portion 120 at the receiving portion 130, a user can tighten or loosen the hinge 100 to accommodate different needs. For example, if the hinge 100 is to be used to rotatably couple a larger door or a hatch, the hinge 100 can be tightened by inserting a tool into the receiving portion 130 and rotating clockwise to engage the male portion 120 into the female portion 125 and cause friction between the washers 135, the first curled portion 105a, and/or the second curled portion 110a. Likewise, to accommodate a lighter door or hatch, the user may rotate the receiving portion counterclockwise to reduce the amount of friction between the washers 135, the first curled portion 105a, and/or the second curled portion 110a.

The sex bolt 117 can be pressed with a tool to form an indent 145, as shown in FIGS. 1-3. The indent 145 presses against the threaded shaft 120b and substantially prevents the loosening of the sex bolt 117 once the indent 145 is pressed. Alternately, the tubular threaded cavity 125b can be pressed with the tool to form the indent 145, and such an indent 145 can function in substantially the same way as the indent 145 formed on the second curled portion 110a.

The washers 135 of the present application can provide advantageous properties relative to conventional friction hinges. For example, the washers 135 may be made from phosphorus bronze, beryllium copper, brass, stainless steel and 17-4 PH hardened stainless steel, for example. The inventors of the present application discovered that the above materials are advantageous when used in washers for a friction hinge configuration like that shown in the figures. For example, the inventors discovered that a three washer configuration including a first washer made of phosphor bronze, a second washer made of stainless steel, and a third washer made of phosphor bronze, frictionally coupled together with advantageous wear properties. That is, the three washer configuration discussed above provides sufficient friction to ensure the desired angular position of the hinge 100 even after many rotations. Likewise, the inventors discovered that washers 135 made of beryllium copper, brass, 17-4 PH hardened stainless steel or any combination of the above materials, are advantageous for wear properties.

As shown in FIG. 4, the hinge 135 can be a grooved washer 150 including a washer body 155 and a groove 160 extending through the washer body 155. The groove 160 allows lubricant, such as oil, to be applied to the washer 150 so as to increase the lifespan of the washer 160. As shown, the groove 160 extends radially from an outer diameter of the washer 150 to the inner diameter of the washer 150. However, any shaped groove 160 can be implemented without departing from the spirit and scope of the present application.

To adjust the friction hinge 100, a user can attach the hinge 100 to the two components in which the hinge 100 should be pivotally coupled, and insert a tool into the receiving portion 130. The user can then rotate the tool clockwise to tighten the friction hinge 100, or rotate the tool counterclockwise to loosen the friction hinge.

As shown in the figures, the hinge 100 can be a top mount or flush mount hinge, however, any form of hinge can be implemented without departing from the spirit and scope of the present application. For example, without limitation, the hinge 100 can be a top mount, flush mount, swaged, offset or any other form of barrel hinge.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. An adjustable friction hinge comprising:
a first leaf including a first curled portion;
a second leaf hingedly coupled to the first leaf, the second leaf including a second curled portion;
a sex bolt disposed within the first and second curled portions and coupling the first leaf to the second leaf, the sex bolt including a female portion with a female portion head and a tubular cavity extending from the female portion head, and a male portion having a male portion head and a shaft extending from the male portion head into the tubular cavity;
a first washer component concentrically disposed about the sex bolt and adapted to frictionally engage the female portion head and one of the first and second curled portions;
a second washer component concentrically disposed about the sex bolt and adapted to frictionally engage the first and second curled portions; and
a third washer component concentrically disposed about the sex bolt and adapted to frictionally engage the male portion head and one of the first and second curled portions,
wherein rotation of at least one of the male portion head and the female portion head is adapted to increase a compressive force applied to at least one of the first, second, and third washer components to thereby increase friction applied to the at least one of the first, second, and third washer components and increase a force required to rotate the at least one of the first and second leaves.

2. The adjustable friction hinge of claim 1, wherein at least one of the first, second, and third washer components includes a plurality of washers composed of at least one material selected from the group consisting of phosphorus bronze, beryllium copper, brass, stainless steel, and 17-4 PH hardened stainless steel.

3. The adjustable friction hinge of claim 2, wherein the at least one of the first, second, and third washer components includes at least one group of washers having a first washer composed of phosphor bronze, a second washer disposed adjacent the first washer and composed of stainless steel, and a third washer disposed adjacent the second washer and composed of phosphor bronze.

4. The adjustable friction hinge of claim 2, wherein the at least one of the first, second, and third washer components includes at least one group of washers having a first washer, a second washer disposed adjacent the first washer, and a third washer disposed adjacent the second washer, wherein the first, second, and third washers are each composed of phosphor bronze.

5. The adjustable friction hinge of claim 1, wherein the tubular cavity is adapted to threadingly engage the shaft.

6. (canceled)

7. The adjustable friction hinge of claim 1, wherein at least one of the male portion head and the female portion head include a receiving portion adapted to receive a tool for rotational movement.

8. The adjustable friction hinge of claim 1, wherein the first and second leaves include openings adapted to receive a fastener and couple the adjustable friction hinge to a base.

9. The adjustable friction hinge of claim 1, further comprising an indent formed in at least one of the first and second curled portions and adapted to press against the sex bolt.

10. The adjustable friction hinge of claim 9, wherein the indent is formed in the first curled portion of the first leaf.

11. The adjustable friction hinge of claim 9, wherein the indent is formed in female portion of the sex bolt.

12. A method of adjusting a friction hinge comprising:
hingedly coupling a first leaf to a second leaf by disposing a sex bolt in a first curled portion of the first leaf and a second curled portion of the second leaf, the sex bolt including a female portion with a female portion head and a tubular cavity extending from the female portion head, and a male portion having a male portion head and a shaft extending from the male portion head into the tubular cavity;
concentrically disposing a first washer component about the sex bolt, the first washer component adapted to frictionally engage the female portion head and one of the first and second curled portions;
concentrically disposing a second washer component about the sex bolt, the second washer component adapted to frictionally engage the first and second curled portions;
concentrically disposing a third washer component about the sex bolt, the third washer component adapted to frictionally engage the male portion head and one of the first and second curled portions;
rotating at least one of the male portion head and the female portion head to increase a compressive force applied to at least one of the first, second, and third washer components to thereby increase a force required to rotate the at least one of the first and second leaves.

13. (canceled)

14. The method of claim 12, wherein the step of disposing the first, second, or third washer components includes disposing, about the sex bolt, at least one first washer adjacent the first curled portion and at least one second washer adjacent the second curled portion.

15. The method of claim 12, wherein at least one of the first, second, and third washer components includes a plurality of washers composed of at least one material selected from the group consisting of phosphorus bronze, beryllium copper, brass, stainless steel, and 17-4 PH hardened stainless steel.

16. The method of claim 15, wherein the step of disposing the first, second, or third washer components includes disposing, about the sex bolt, at least one group of washers having a first washer composed of phosphor bronze, a second washer disposed adjacent the first washer and composed of stainless steel, and a third washer disposed adjacent the second washer and composed of phosphor bronze.

17. The method of claim 15, wherein the step of disposing the first, second, or third washer components includes disposing, about the sex bolt, at least one group of washers having a first washer, a second washer disposed adjacent the first washer, and a third washer disposed adjacent the second washer, wherein the first, second, and third washers are each composed of phosphor bronze.

18. The method according to claim 12, further comprising forming an indent in one of the first and second leaves, wherein the indent is adapted to press against the sex bolt.

19. The method according to claim 18, wherein forming the indent includes forming the indent in the first curled portion of the first leaf.

20. The method according to claim 18, wherein forming the indent includes forming the indent in the female portion of the sex bolt.
